(19) United States
(12) Patent Application Publication
(10) Pub. No.: US 2006/0042515 A1
(43) Pub. Date: Mar. 2, 2006

(54) Agglomerated perlite

(76) Inventors: Frederick M. Bodycomb, Springfield, CO (US); Charles S. Smith, Hudson, OH (US)

Correspondence Address: Timothy B. Smith, Suite 1300, 185 South State Street, Salt Lake City, UT, 84111, US

(21) Appl. No.: 10/930,068

(22) Filed: Aug. 30, 2004

(51) Int. Cl. C04B 14/18

(52) U.S. Cl. 106/698

(57) ABSTRACT

Perlite, a volcanic glass, is used in a variety of horticultural, construction and industrial applications. In order to be put to such uses, mined perlite ore is crushed and screened to size and then expanded by being passed through a flame at high temperature. During the expansion phase, up to 50% of the perlite may be unintentionally fractured, resulting in very fine perlite material with little or no commercial application. The method and product of the present invention converts saleable expanded perlite, as well as fine perlite material (which is of such a size and quality that it is of no value to a manufacturer and is difficult to dispose of) into a relatively dust free product with numerous end applications, some of which are new uses for perlite.

### FIELD OF THE INVENTION

The present invention relates to expanded perlite and methods of agglomeration and use of expanded perlite that is presently produced and sold, as well as methods of agglomeration and use of expanded perlite fines presently not saleable or useable.

### BACKGROUND OF THE INVENTION

Expanded perlite is used in a variety of horticultural, construction and industrial applications. Perlite is a naturally occurring hydrated volcanic glass formed by the alteration of obsidian. Typically, perlite is composed of silicon dioxide (72-75%), alumina (12-14%), iron oxide (approximately 1%), as well as compounds of calcium, potassium, sodium, titanium, and other elements (all in quantities of less than 5%). In order to obtain expanded perlite, crude perlite ore is mined, crushed, dried in a rotary dryer, milled, sized (usually by screening), and shipped to expansion plants. The sized perlite is expanded in order to obtain very low density frothy bubbles in the material. Expansion is accomplished because of the presence of two to six percent combined water in the crude perlite rock. When quickly heated to above 870° C. (1598° F.), the crude rock pops in a manner similar to popcorn as the glassy ore particles soften in the flame while the combined water in the ore turns to steam and expands forming the numerous low density bubbles mentioned previously.

The advantages of using expanded perlite are well known. It is very light weight, has exceptional moisture absorption and retention capabilities and outstanding insulating characteristics. In construction, expanded perlite is widely used as loose fill insulation in masonry construction. Expanded perlite is poured into the cavities within the masonry block and provides thermal insulation, acoustical insulation, enhanced fire ratings and is rot resistant. Perlite can also be used as an aggregate in Portland cement concrete, and is used in Portland cement and gypsum plasters, ceiling tile, insulating board, etc. resulting in low density, fire-resistant products.

Additionally, large particle sized expanded perlite is used for a variety of horticultural purposes, primarily as an additive to soils. In this capacity, it provides aeration and moisture retention to aid in superior plant growth. A wide range of mixture ratios can be used with perlite. In some instances, a small amount of perlite is added to soil, while in others, 100% perlite is utilized, such as when used for hydroponic plantings. Agglomerated expanded perlite is weed-free and can be used as a carrier for fertilizer, herbicides, pesticides and seeds. In horticultural applications, expanded perlite is used in everything from house plants to large commercial greenhouses to golf courses.

Finally, expanded perlite has many industrial applications. It can be used as a filler in plastics, as an additive to cement used in the drilling of oil, gas, water and geothermal wells, or as filter material for the clarification of pharmaceuticals, beverages, chemicals, water, etc. Nevertheless, while there are numerous uses for expanded perlite, there are, with certain exceptions, essentially no uses for the fine expanded perlite that remains after the expansion process.

There are several varieties of perlite ore. The two primary types of perlite ore used commercially are granular and classical “onion-skin.” While expanded ore fines produced from certain classical types are valuable for use as a filter aid, fines produced from granular types are often of little or no commercial value. Pelletization of fines from expanded granular ore would, therefore, be of greater utility. It is the intent of this patent, however, to include the agglomeration of expanded material from both types of perlite.

During the expansion process, unintended and unwanted fracturing of the perlite occurs, resulting in the production of perlite fines. The fines are removed from the expanded perlite in a cyclone and collected in a baghouse. Up to 50% of the material introduced to the expansion process may end up as fines. A small amount of the resulting fines, if of the right size and quality, may be used in insulations and fine plasters. Most of the fine material, however, has few if any commercial uses. It is also costly to store and dispose of the essentially unusable and worthless fine perlite material.

Accordingly, there is a need to utilize the massive amounts of these otherwise unusable perlite fines that are accumulating in or near perlite expansion facilities. There is also a need for material that possesses the properties of saleable expanded perlite in a less dusty form. Expanded perlite can be extremely dusty, limiting possible applications of the product. There is therefore also a need for a relatively dust-free expanded perlite product.

### SUMMARY OF THE INVENTION

The present invention provides a solution to existing needs as well as many others. By agglomerating presently unusable perlite fines, a new perlite product is created. This is of particular use in converting fine expanded perlite into valuable, large-particle horticultural grades. The perlite fines that would otherwise be discarded can be made into a useful product, while at the same time the supply of material with commercially valuable expanded perlite qualities is increased.

New uses are possible for the relatively dust-free agglomerated perlite. One such new use is for “cavity fill” insulation in such areas as between joists in attics and between studs in walls. Expanded perlite as now sold is too dusty to be used in such areas. Agglomerated dust-free perlite in granular or pellet form would be ideal for such applications.

A second new use for agglomerated perlite would be for cryogenic insulation. Vibration would not cause the agglomerated particles to settle in the cavity of a container or vessel to the extent that loose, small-particle perlite, which is currently in use, settles.

A third new use for agglomerated perlite would be for aerial reseeding of fire-burned or otherwise denuded areas. Present reseeding in slurry or dry form are susceptible to blowing from wind and have other serious drawbacks. Use of seeds, fertilizer, etc. in a perlite pellet form allows for more accurate placement from an aircraft, permits reseeding to proceed in windier conditions, and has other benefits.

A fourth new use would be to allow the use of fine perlite for horticultural purposes that would otherwise require large particle size perlite, simply by agglomerating the fine perlite to the appropriate size.

An additional new use for agglomerated perlite would be as an absorbent material in stockyards and as poultry litter. When the area(s) so treated are cleaned out, the mixture of manure and perlite could be more useful when applied to agricultural land than manure alone.

Other new uses will become evident as the production of agglomerated perlite becomes established.

It is an object of the invention to provide a commercially valuable expanded perlite agglomerate that retains all of the qualities of expanded perlite (as presently produced), in a relatively dust-free form.

It is a further object of the invention to provide a perlite agglomerate that uses expanded perlite fines, which would otherwise be discarded, to serve as a replacement for more expensive expanded perlite.

According to one aspect of the invention, agglomerated perlite may be used for new applications such as aerial reseeding and new cavity fill insulation markets for which loose and dusty expanded perlite as now produced is not useable.

According to another aspect fo the invention, an expanded perlite product, comprised of expanded perlite or expanded perlite fines and a binder is produced. The expanded perlite agglomerates are produced by an agglomeration process. The agglomeration process uses a tumble/agitative agglomeration method, such as a pelletizing disc or granulating drum. The perlite may be formed into a sheet, like paper or cardboard, dried and crushed to form flakes. However, a pressure method, an extrusion method, a pelletizing method, or other agglomeration technology or methods may be used. The expanded perlite agglomerate can be used as a delivery system for seeds. It is an object of the present invention for the tumble/agitative agglomeration technology to comprise tumbling, mixing, granulation, balling, pressing, sheeting or conditioning.

According to another aspect of the invention, the expanded perlite agglomerate comprises expanded perlite and a binder or binders, including but not limited to: liquids, including water, acids, bases, waste liquids, waste liquid/solid mixtures, liquid fertilizers, oils (both vegetable, mineral, natural and refined); sugars; starches; adhesives; polymers; fibers, including cellulose, macerated fabrics, cotton, wool, and polymeric fibers; wollastonite; fuller's earth; gypsum; lime; clay; bentonite; and formaldehyde and/or a combination of same.

According to another aspect of the invention, the expanded perlite agglomerate that possesses the outstanding aeration and moisture retention features of expanded perlite may also comprise seeds and/or fertilizer, insecticides, herbicides, etc., as required, for horticultural/agricultural markets.

According to another aspect of the invention, an agglomerated/pelletized expanded perlite product may be used as a seed delivery system that is produced by either a tumble/agitative, pressure, extrusion, pelletizing, or other agglomeration technology or method. The term agglomeration relates to particle size enlargement theory. An agglomerate is defined as an assemblage of particles, which is either loosely or rigidly joined together, with several particles adhering to each other. A fertilizer, herbicide, or pesticide may be added to the expanded perlite agglomerate of the present invention, as desired.

Another aspect of the invention is to use an agglomerated/pelletized expanded perlite product as a seed delivery system that is relatively resistant to wind dispersal or bird or animal consumption.

Another aspect of the invention is to provide an agglomerated expanded perlite product that can be used for loose/cavity fill thermal insulation.

Another aspect of the invention is to provide an agglomerated expanded perlite product that can be added to concrete, Portland cement and gypsum plasters resulting in a lightweight fire-resistant product.

Another aspect of the invention is to provide an agglomerated expanded perlite product that can be used as a filler in plastic, as an additive to cement used in the drilling of petroleum, water and geothermal wells, or as filter material for pharmaceuticals, chemicals, water, or other fluids.

These and other features and advantages of the preferred embodiment of the present invention will become apparent from the detailed description of the invention.

### DETAILED DESCRIPTION OF THE INVENTION

The basis of this invention is the use of expanded perlite and expanded perlite fines in relatively dust-free agglomerated, pelletized, flaked or granulated form. The agglomerated perlite product may be used as an additive to soils to absorb moisture thus increasing the moisture-holding capacity of the soil, reducing the rate of evaporation and enhancing the retention of moisture in the soil making additional water available to plants over an extended period of time. The agglomerated perlite fines also have the same qualities as more expensive expanded perlite and can be used in many of the same construction and industrial purposes as expanded perlite that are discussed above.

Expanded perlite grades, or expanded perlite fines, are combined with a binder to facilitate the formation of pellets. Numerous additives could be used as binders, including but not limited to, liquids, including water, acids, bases, waste liquids, waste liquid/solid mixtures, liquid fertilizers, oils (both vegetable, mineral, natural and refined); sugars; starches; adhesives; polymers; fibers, including cellulose, macerated fabrics, cotton, wool, wollastonite and polymeric fibers; clay; bentonite; fuller's earth; and formaldehyde.

In a preferred embodiment, expanded grades of commercial perlite or unsaleable expanded perlite fines are mixed with pulped cellulose, corn starch and water. Mixers such as pin mixers, paddle mixers or other types of mixers can be used. Other materials may also be added to the mixture including, but not limited to, fertilizer, insecticides, herbicides, and/or seeds. When using the agglomerated perlite in a horticultural or agricultural use, it is advantageous to use biodegradable materials in the agglomeration process in order to facilitate the disintegration of the agglomerate and its disbursement into the soil. The mixture is then agglomerated in an agglomeration process.

The agglomeration performed to create the agglomerated perlite is done by either a tumbling/agitation method, such as a pelletizing disc or granulating drum (possibly best for lower density applications); a pressure method, such as briquetting (possibly best for higher density applications), tableting and/or pressing; an extrusion method; a pelletizing method, such as pelletizing discs; or other agglomeration technology or methods.

An example of how the expanded perlite or expanded perlite fines can be agglomerated with pressure technology is described below:

A combination of 80% expanded perlite fines, 10% pulped newsprint (fiberized in a blender), 10% corn starch and water (3 times the weight of the dry constituents added with the starch and 0.3 times the weight of the dry constituents added with the pulped newsprint) is mixed by hand. The mixture is then inserted into a cylinder that is closed on one end. Pressure is applied to the mixture through the use of a rod of slightly smaller diameter than the inside diameter of the cylinder, that is inserted into the cylinder. This causes the mixture to compress into a strong expanded perlite agglomerate. The pellets are then dried.

In a preferred embodiment, the expanded perlite agglomerate of the present invention has the following characteristics: relatively dust free; easily handled/transported; rapid and easy cleanup if spilled, waste-free.

Use as a Seed Delivery System

When seeds are included in the mixture of expanded perlite, cellulose, corn starch and water, the resulting agglomerate can serve as an optimal seed delivery system. It is well known that expanded perlite provides exceptional aeration and moisture retention qualities that aid in superior plant growth. When a seed is included in an expanded perlite agglomerate, it is automatically placed in ideal growing conditions. If fertilizer is also included in the expanded perlite agglomerate, the growing conditions become even better. Additionally, because the seeds are encased in the expanded perlite agglomerate, there is less likelihood that the seeds will be eaten by birds or other animals, again increasing the probability of successful seed germination. The size and weight of the expanded perlite agglomerate also provides for more precise placement of the seeds contained therein, and ensures that the seed will not be as easily scattered by wind or rain. Finally, the expanded perlite agglomerate can be manufactured in such a way that the precise ratio of seed/fertilizer is obtained without requiring the user to worry about such ratios.

Use in Industrial Applications

The agglomerated expanded perlite product, which does not contain seed, fertilizer, etc., possesses similar qualities as expanded perlite that make it suitable for many industrial purposes. Certain binders, such as gypsum, lime, various polymers and adhesives, can be utilized to prevent any degradation of the agglomerated expanded perlite product so that it can be used, for example, as a filler in plastics or as an aggregate with cement used in light weight concrete, or in the drilling of petroleum, water and geothermal wells. The use of expanded perlite fines in the agglomeration process for industrial applications can also lead to substantially reduced costs as well as the utilization of what would otherwise be a waste product.

Use in Construction Applications

Similarly, the agglomerated expanded perlite product, which does not contain seed, fertilizer, etc., possesses similar qualities as expanded perlite that make it suitable for several construction applications. As such, the agglomerated expanded perlite product can be used as an aggregate in concrete, and Portland cement and gypsum plasters resulting in lightweight fire-resistant products. A major use might be as cavity fill thermal insulation. Again, such uses that utilize expanded perlite fines in the agglomeration process can lead to substantially reduced costs as well as the utilization of what would otherwise be a waste product.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention. This would include coating the pellets or granules for certain uses.

What is claimed is:

1. An expanded perlite product, comprised of agglomerated expanded perlite wherein
said agglomerated expanded perlite are produced by an agglomeration process;
said agglomeration process uses a tumble/agitative agglomeration technology.

2. The expanded perlite product of claim 1 wherein said tumble/agitative agglomeration technology uses a granulating drum,

3. The expanded perlite product of claim 1 further comprising a binding agent or combination of binding agents.

4. The expanded perlite product of claim 3 wherein the binding agent is at least one of the group of water, acids, bases, waste liquids, waste liquid/solid mixtures, liquid fertilizers, oils, sugars, starches, adhesives, polymers, fibers, cellulose, newsprint, macerated fabrics, cotton, wool, wollastonite, gypsum, lime, polymeric fibers, clay, bentonite, fuller's earth, or formaldehyde.

5. The expanded perlite product of claim 1 further comprising grass, tree, shrub or other vegetation seed.

6. The expanded perlite product of claim 5 further comprising fertilizer.

7. The expanded perlite product of claim 5 further comprising at least one of the group of pesticide, insecticide, or rodenticide.

8. The expanded perlite product of claim 5 further comprising a herbicide.

9. An expanded perlite product, comprised of agglomerated expanded perlite wherein
said expanded perlite agglomerates are produced by an agglomeration process;
said agglomeration process uses pressure agglomeration technology.

10. The expanded perlite product of claim 9 wherein said pressure agglomeration technology uses a briquetting, tableting or pressing machine, or the formation of sheets to produce flakes.

11. The expanded perlite product of claim 9 further comprising a binding agent or combination of binding agents.

12. The expanded perlite product of claim 11 wherein the binding agent is at least one of the group of water, acids, bases, waste liquids, waste liquid/solid mixtures, liquid fertilizers, oils, sugars, starches, adhesives, polymers, fibers, cellulose, newsprint, macerated fabrics, cotton, wool, wollastonite, polymeric fibers, clay, bentonite, fuller's earth, or formaldehyde.

13. The expanded perlite product of claim 9 further comprising grass, tree, shrub or other vegetation seed.

14. The expanded perlite product of claim 13 further comprising fertilizer.

15. The expanded perlite product of claim 13 further comprising at least one of the group of pesticide, insecticide, or rodenticide.

16. The expanded perlite product of claim 13 further comprising a herbicide.

17. An expanded perlite product, comprised of expanded perlite agglomerates wherein
said expanded perlite agglomerates are produced by an agglomeration process;
said agglomeration process uses extrusion agglomeration technology.

18. The expanded perlite product of claim 17 wherein said extrusion agglomeration technology uses known equipment to produce agglomerates of various desired configurations.

19. The expanded perlite product of claim 17 further comprising a binding agent or combination of binding agents.

20. The expanded perlite product of claim 19 wherein the binding agent is at least one of the group of water, acids, bases, waste liquids, waste liquid/solid mixtures, liquid fertilizers, oils, sugars, starches, adhesives, polymers, fibers, cellulose, newsprint, macerated fabrics, cotton, wool, wollastonite, polymeric fibers, clay, bentonite, fuller's earth, or formaldehyde.

21. The expanded perlite product of claim 17 further comprising grass, tree, shrub or other vegetation seed.

22. The expanded perlite product of claim 21 further comprising fertilizer.

23. The expanded perlite product of claim 21 further comprising at least one of the group of pesticide, insecticide, or rodenticide.

24. The expanded perlite product of claim 21 further comprising a herbicide.

25. An expanded perlite product, comprised of agglomerated expanded perlite wherein
said expanded perlite agglomerates are produced by an agglomeration process;
said agglomeration process uses pelletizing agglomeration technology.

26. The expanded perlite product of claim 25 wherein said pressure agglomeration technology uses pelletizing discs.

27. The expanded perlite product of claim 25 further comprising a binding agent or combination of binding agents.

28. The expanded perlite product of claim 27 wherein the binding agent is at least one of the group of water, acids, bases, waste liquids, waste liquid/solid mixtures, liquid fertilizers, oils, sugars, starches, adhesives, polymers, fibers, cellulose, newsprint, macerated fabrics, cotton, wool, wollastonite, polymeric fibers, clay, bentonite, fuller's earth, or formaldehyde.

29. The expanded perlite product of claim 25 further comprising grass, tree, shrub or other vegetation seed.

30. The expanded perlite product of claim 29 further comprising fertilizer.

31. The expanded perlite product of claim 29 further comprising at least one of the group of pesticide, insecticide, or rodenticide.

32. The expanded perlite product of claim 29 further comprising a herbicide.

33. The expanded perlite product of claim 25 further comprising a coating to enhance performance in certain end uses.

34. The expanded perlite product of claim 25 further comprising a coating which imparts water repellency to said pellets, such as silanes, silicones, vinyl compounds, or other polymers.
